(19) United States
(12) Patent Application Publication
(10) Pub. No.: US 2015/0069690 A1
(43) Pub. Date: Mar. 12, 2015

(54) USE OF AN ADJUSTING ELEMENT FOR ALIGNMENT OF INCLINED SURFACES OF TEST BODIES, AND DEVICE COMPRISING SAID ADJUSTING ELEMENT, AND METHOD FOR PRODUCING AN ADHESIVE BOND BETWEEN ADHESIVES AND A TOOTH SURFACE

(71) Applicant: Heraeus Kulzer GmbH, Hanau (DE)

(72) Inventors: Astrit KASTRATI, Wollstadt (DE); Marcus HOFFMANN, Usingen (DE); Waltraut MUELLER, Frankfurt (DE)

(21) Appl. No.: 14/478,276

(22) Filed: Sep. 5, 2014

(30) Foreign Application Priority Data
Sep. 9, 2013 (DE) 10 2013 109 811.8

(51) Int. Cl. B23Q 3/18

(52) U.S. Cl. CPC B23Q 3/186
USPC 269/37; 29/559

(57) ABSTRACT

At least one adjusting element aligns a first surface of a test body, comprising a dentine and/or enamel surface, plane-parallel with respect to a contact surface and/or to at least one second surface, which is optionally coated with an adhesive dental material. The at least one adjusting element in a device is usable to produce an adhesive bond at the contact surface between the first surface and the at least one second surface. A method determines necessary force to be applied to separate or break the adhesive bond at the force surface and/or contact surface between the first and the at least one second surface.

The present invention relates to the use of at least one adjusting element for plane-parallel alignment of a first surface, in particular of a test body comprising a dentine and/or enamel surface, with respect to a contact surface and/or to at least one second surface, in particular with respect to a contact surface on which a self-adhesive dental material or a non-adhesive dental material in the form of a three-dimensional mold contacts a first surface, which is optionally coated with an adhesive dental material, as well as the use of the at least one adjusting element in a device, in particular in a device for producing an adhesive bond at the contact surface between the first surface and the at least one second surface, and a method for determining the force that needs to be applied to separate or break the adhesive bond, in particular in the form of a three-dimensional mold, at the force surface and/or contact surface between the first and the at least one second surface (FIG. 6).

The adhesion to enamel and dentine is an important property of dental materials, in particular dental adhesives or self-adhesive dental materials or, if applicable, dental materials for modelling. The so-called shear bond strength test is used to measure how well a dental material or dental adhesive adheres to a tooth and/or a surface of a tooth. The method for determination of the shear bond strength is carried out according to DIN EN ISO 29022:2013 through embedding human or bovine teeth in dental hard plaster or acrylic resin, preferably in self-curing acrylic resins. The test bodies thus produced are then polished and processed further in accordance with DIN EN ISO 29022:2013.

The entire method, in particular in accordance with DIN EN ISO 29022:2013, can be subdivided into two procedural sections and/or two separate methods. In the first section, an adhesive bond is produced in a first device, and the adhesive bond is broken in a second device in a second section. Said method and/or both sections of the method are associated with multiple challenges. Firstly, a test body comprising the relevant surface for adhesion of a dental material, in particular of a tooth, needs to be produced. For this purpose, the tooth comprising the surface relevant for adhesion usually needs to be embedded into an acrylic resin and then this surface needs to be made accessible. For this purpose, the test body obtained after light-mediated or chemically mediated curing, which is usually cylindrical in shape, is polished to be flat in order to expose a sufficient surface area of the surface relevant for adhesion of a dental material, such as tooth substance, in particular enamel and dentine, for the test. Due to the shrinkage of the embedding material, such as acrylic resin, a test body with inclined surfaces and/or surfaces that are not plane-parallel with respect to each other, in particular upper sides and undersides, is obtained (FIG. 7a). Frequently, this is a problem since the test body has to be plane-parallel to be clamped into the first device according to the prior art, in particular for producing an adhesive bond (FIG. 4). Therefore, the opposite underside and/or base of the test body facing away from the surface to be tested, also needs to be polished such as to be flat which is difficult to achieve in manual polishing processes. If the surface that is relevant for adhesion of a dental material and/or the first surface and the underside of the test body are not plane-parallel with respect to each other, a device according to the prior art for producing an adhesive bond between the shaped part placed on the test body for introduction of a dental material, such as, e.g., an Ultradent mold, and the first surface, such as enamel or dentine, produces a gap (FIG. 7b).

In a subsequent step, a dental material, in particular composite, such as self-adhesive dental material or non-adhesive dental material, or adhesive is filled into the sample well, which leads to leakage of dental material through the gap from the sample well and distortions when surfaces that are not plane-parallel are used in the device according to the prior art (FIG. 7b). The distortions produced from the leaking dental material increase the adhesive surface between test body and the dental material to be tested for adhesion beyond the desired contact surface. Said increased adhesive surface can possibly spread to the surrounding embedding material of the test body. As a result, an extended adhesive bond is produced that includes a desired adhesive surface in the region of the contact surface between a dental material, such as a composite, and a tooth surface, possibly treated with a dental adhesive, and, in addition, an undesired adhesive surface between the spread dental material in the form of the distortion and, possibly, the embedding material, whereby said adhesive surfaces are connected to each other. The adhesive bond, which is extended by the distortions one these have cured, renders the last step more difficult, i.e. the clamping of the three-dimensional mold of the dental material, as obtained by means of a shaped part after the curing, into the test equipment and/or a device for exertion of a force. This device measures the force that causes the adhesive bond to break at the actual adhesive surface, which, according to the prior art, is not restricted to the relevant and desired contact surface. Said enlarged surface, in case the distortion is extensive, falsifies the results, since the real contact surface between tooth surface and dental material is smaller than the actual and/or real (adhesive) surface. The analysis considers the force per unit area of the adhesive bond at the contact surface, whereby said unit area is a standardized value that is given by the geometry of a mold. Accordingly, the surface area used for calculation differs strongly from the actual surface area including a distortion actually measured. The surface area plus distortion cannot be converted easily, since the distortion fails has no definite geometry. Moreover, surface properties of the embedding material, which might also be wetted, in the region of the adhesive surface differ from those of the, possibly adhesive-pretreated, tooth surface (dentine, enamel) such that there is a different adhesive strength which falsifies the measured value obtained at fracture of the entire adhesive bond.

Another problem is the loss of material due to dental material leaking from the gap, which results in the need to use more material to fill the sample well. Moreover, the lengthy manual polishing of the test body into a plane-parallel geometry leads to a large loss of material. As a result, the total height of the test body is decreased strongly, which renders the clamping into the device for producing an adhesive bond between the first surface and a second surface, in particular in accordance with DIN EN ISO 29022:2013, no longer feasible. According to DIN EN ISO 29022:2013, it is permissible to compensate the height of the test body using up to 12 microscope slides in order to attain the required minimal height of 20 mm. In this context, the microscope slides are glued together with adhesive tape and are then positioned on the underside of the test body. This is cumbersome and leads to instability of the arrangement of stacked elements, such as slides, test body, and shaped part, in a device according to the prior art for producing the adhesive bond. It is a disadvantage of microscope slides that the compensation of height can only be done in steps equal to the thickness of the individual microscope slide, which ranges from 1.0 mm to 1.5 mm according to the prior art, e.g. in accordance with DIN ISO 8037-1. Regardless of which microscope slides are used, step-less or continuous height adjustment deviating from the thickness of the individual microscope slide, is not feasible. Another disadvantage of the microscope slides, which usually consist of glass, is their low breaking strength which can lead to breakage of the cover slides when the test body is clamped under a shaped part in the device up to the pressure required for frictional connection.

U.S. Pat. No. 6,324,916 B1 discusses the afore-mentioned challenges associated with the measurement of a shear bond strength and describes, for improvement of the accuracy of the measurement, a shearing device that exerts the shearing force by means of a shaped part for exertion of the shearing force via a minimal contact surface on a mold of a dental material. However, U.S. Pat. No. 6,324,916 B1 does not provide a solution for the generation of distortions and thus for the problem of the contact surface being ill-defined and the surface of the adhesive bond being falsified.

Therefore, the current method still is associated with significant disadvantages such as i), the time-consuming polishing of the test bodies, ii) the unattainable plane-parallel position of the tooth surface to be tested (enamel and dentine) of the test body, iii) the needed compensation by means of the easily breaking microscope slides facilitating a height compensation only, but not compensation of the inclined position of the test body, iv) and thus the generation of gaps between tooth surface and the device for producing an adhesive bond with the composite, v) consequently, the leakage of the dental material, in particular composite, and the ensuing loss of material, and vi) the formation of distortions and thus generation of a falsified surface area in the force measurement, which vii) causes falsified shear bond strength results and thus falsified bond strength results of the dental material on tooth surfaces.

It is therefore the object of the present invention to preclude the afore-mentioned disadvantages, in particular the formation of distortions, by optimizing a device and through the use of said device in a method for producing an adhesive bond between at least one dental material and a tooth surface in accordance with DIN EN ISO 29022:2013. It is an object of the present invention to provide a device that ensures a plane-parallel arrangement of a first surface of a test body, in particular of a dentine and/or enamel surface of a tooth, and a contact surface, at which at least one second surface, in particular a surface of an adhering dental material, such as an adhesive, self-adhesive dental material, such as a composite, or non-adhesive dental material, such as filling material, contacts the first surface. Moreover, the invention is to provide a device that prevents the formation of gaps upon the use of a shaped part between a first surface of a test body and a contact surface, in particular at least one second surface, and prevents the leakage of dental material from the shaped part and thus the formation of distortions. The specific object of the invention is to provide the use of a device, which, if the shaped part is used, does not comprise a gap between the lower sample opening and/or the lower edge of the shaped part and at least one first surface of a test body, optionally a first surface coated with an adhering dental material, such as adhesive, such that no dental material leaks between a first surface and the lower edge of the shaped part. Moreover, it is another object of the present invention to ensure a defined and reproducible contact surface between a first surface and at least one second surface, in particular in the form of a three-dimensional mold. It is another object to ensure a defined and reproducible adhesive surface of the adhesive bond between a first and at least one second surface that coincides with the contact surface and thus to provide a reproducible method for producing an adhesive bond with at least one defined adhesive surface and geometry as well as a reproducible method for determining the adhesive strength of a dental material on a tooth surface, in particular enamel and/or dentine, in particular a reproducible method for determining the shear bond strength in accordance with DIN EN ISO 29022:2013 with reproducible measuring results expressed as force per unit area.

The solution of the objects is described by means of the subject matters of the independent patent claims and, in actual embodiment, in the dependent claims and, in detail, in the description and the figures. The figures are schematic drawings that do not necessarily have to be true to scale and just show the essential components and the essential arrangement.

One subject matter of the present invention is the use of at least one adjusting element, as shown in FIGS. 1a to 1g, for alignment of the height and/or inclination of a first surface of a test body and/or Ultradent test body into a plane-parallel position with respect to at least one contact surface and/or with respect to at least one second surface in a device, in particular in a device for producing an adhesive bond (see FIG. 4). Said device according to the invention for producing an adhesive bond is shown in FIG. 2, FIG. 4, and FIG. 7c.

The device, in particular measuring facility, which preferably can also comprise a clamping device having at least one fixation element, in which a sample may need to be aligned, comprises all measuring facilities, in which a vertical impact is exerted on the sample and in which a non-plane-parallel surface and/or the angle between the surface to be tested and the source of said impact can affect the measuring results. Conceivable impacts include physical forces such as gravitation, electromagnetic interactions in the form of light, electricity, magnetism as well as thrust force, traction force, shearing force, and centrifugal forces. Such sensitive measuring facilities include, in particular, camera-coupled devices comprising microscopes, such as light microscopes, laser microscopes (LSM, CLSM), X-ray, ultrasound, magnetic resonance, and scanning microscopes (AFM, SFM and RKM), CCD camera-coupled devices, devices for measuring physical and physico-chemical interactions such as contact angle measurement. Accordingly, another subject matter of the present invention is the use of at least one adjusting element, as shown in FIG. 1, for alignment of the height and/or inclination of a first surface of a test body into a plane-parallel position with respect to a contact surface and/or with respect to at least one second surface, whereby the test body is a sample that is to be tested, in particular a microscopy sample.

During the use according to the invention, the at least one adjusting element is being positioned at the underside of a test body, which concurrently is the side facing away from the first surface. As a result, the test body and/or the first surface are being aligned to be plane-parallel with respect to the source of the impact, in particular with respect to a shaped part.

During the use according to the invention, the alignment is done with at least one adjusting element, whereby a) the height of the adjusting element is continuously adjustable, in particular step-less, or in steps in a range of more than or equal to 0 mm, in particular to less than or equal to 100 mm, and/or b) the inclination of the adjusting element is continuously adjustable, in particular step-less, or in steps up to an angle alpha of more than or equal to 0 angular minutes, in particular up to less than or equal to 60° between a plane E and plane Eₐₗₚₕₐ of the adjusting element and the underside of the test body. Accordingly, (i) the height of the test body, in particular of the first surface, can be aligned by adjusting the height of the adjusting element while keeping the angle of the adjusting element constant, (ii) the inclination of the test body, in particular of the first surface, can be aligned by adjusting the angle of the adjusting element while keeping the height constant, or (iii) the height and the inclination of the test body, in particular of the first surface, can be aligned by adjusting both the height and the angle of the adjusting element.

The height of the adjusting element can be adjusted in a range from more than or equal to 0 mm, in particular to less than or equal to 100 mm, preferably in a range from more than or equal to 0 mm to less than or equal to 100 mm, from more than or equal to 4 mm to less than or equal to 100 mm, from more than or equal to 4 mm to less than or equal to 80 mm, from more than or equal to 4 mm to less than or equal to 70 mm, from more than or equal to 4 mm to less than or equal to 60 mm, from more than or equal to 4 mm to less than or equal to 50 mm, from more than or equal to 4 mm to less than or equal to 40 mm. The height can be adjusted in step-less manner or in steps, in particular in steps of 1 mm. The inclination of the adjusting element can be adjusted through variation of angle alpha between plane E and plane Eₐₗₚₕₐ, whereby plane E of the test body floor space corresponds to a position that is plane-parallel to the base, and plane Eₐₗₚₕₐ corresponds to the inclined test body floor space. The angle alpha can be adjusted in a range from more than or equal to 0′ angular minutes, in particular to less than or equal to 60° degrees, step-less or in steps. Preferably, in a range from more than or equal to 0° to less than or equal to 50°, from more than or equal to 0° to less than or equal to 45°, from more than or equal to 0° to less than or equal to 40°, from more than or equal to 0° to less than or equal to 35°, from more than or equal to 0° to less than or equal to 30°, particularly preferably from more than or equal to 0° to less than or equal to 25°. In particular, the angle alpha can be varied in small steps (1°=60′ angular minutes) of more than or equal to 0′, 6′, 12′, 24′, 30′, 36′, 42′, 48′, 54′, and to less than or equal to 60′ angular minutes and minute inclinations of less than or equal to 1° degree, preferably of less than or equal to 60′, 54′, 48′, 42′, 36′, 30′, 24′, 12′, to less than or equal to 6′ angular minutes can be fine-adjusted. In particular, step-wise adjustment of angle alpha in a range from more than or equal to 0° to less than or equal to 10° in angular minute [′] steps of 30′ is preferred. Preferably, the angle-adjustable component is a ball-shaped element and/or comprises a ball joint with three degrees of freedom.

In particular, step-less and/or continuous adjustment of the height and/or inclination of the adjusting element is another advantage of the use, according to the invention, of the adjusting element as compared to the use of cover glasses according to the prior art for adjusting the height, whereby the thickness of the cover glasses defines a step-wise adjustment. Using cover glasses as used according to the prior art, in particular in accordance with DIN EN ISO 29022, preferably DIN EN ISO 29022:2013, it is not possible to compensate the inclination of the tooth surface on which the adhesion of a dental material is to be tested. The use of the adjusting element according to the scope of the invention enables such compensation of the inclination and thus eliminates the main reason for the generation of distortions, namely gaps due to the first surface being in an inclined position. Specifically with oblique test body and/or test bodies whose surfaces are not plane-parallel, the use of cover glasses in the device for producing an adhesive bond according to the prior art does not allow tightness between first surface and lower edge of a shaped part to be attained. Consequently, this causes the lack of a defined and reproducible contact surface according to the prior art and therefore, ultimately, the falsified adhesive surface and the falsified measuring results in the determination of the adhesion and/or shear bond strength, in particular in accordance with DIN EN ISO 29022, preferably DIN EN ISO 29022:2013. Said disadvantages are eliminated through the use, according to the invention, of the adjusting element.

For this reason, another subject matter of the present invention is the device comprising the adjusting element as well as the use, according to the invention, of the adjusting element, as described above, whereby the second surface is a surface of at least one adhering dental material, self-adhesive dental material and/or non-adhesive dental material in the form of a three-dimensional mold. In particular, the mold has a three-dimensional geometry that corresponds to the negative shape of the sample well of a shaped part. Preferably, the geometry of the mold is adapted to a shaped part of a device in shape-matching manner and/or the shaped part is designed to match the geometry of the mold. Preferably, the mold has a cylindrical geometry.

The geometry of the mold is pre-defined, in particular, by the design of the sample well of a shaped part used to apply the material to be tested, presently at least one adhering dental material, self-adhesive dental material and/or non-adhesive dental material, onto the first surface. A sample well of this type and/or the internal wall and the lower edge of the sample well of a shaped part border(s) the area and/or region on the first surface that is covered by the dental material to be tested. Said bordered area corresponds to the contact surface (FIG. 3a) at which adhesion and/or interactions are permitted between the first surface and the at least second surface leading to an adhesive bond. As a result, a defined adhesive surface of an adhesive bond in the scope of the invention is attained.

Adhesion describes a complex process at the phase boundary of the materials involved in the process. Adhesion is understood to be the phenomenon resulting from interactions on the atomic and/or molecular level that is apparent as the resistance to a separating load acting on the composite.

In particular, the use, according to the invention, of the pre-scribed adjusting element, preferably in a device, involves that the shaped part is aligned such that at least one defined contact surface and thus at least one reproducible adhesive surface, for example of a non-adhesive dental material, such as a filling material, with respect to the adhesive (FIGS. 5b and 5c) or, in the case of self-adhesive dental materials, such as self-adhesive filling/cement materials, with respect to the tooth (FIG. 5a) is attained in the scope of the invention. Using the adjusting element in this context, the formation of gaps between a first surface and the lower edge of a shaped part is precluded. As a result, no dental material that is not yet cured, leaks from the sample well at the lower edge and/or through the lower sample opening. Accordingly, the formation of distortions is precluded such that defined and reproducible adhesive surfaces are obtained in the adhesive bond, in particular of a three-dimensional shape (FIGS. 5a to 5c). A defined adhesive surface, in turn, provides for a reproducible measurement of the shear bond strength, in particular in accordance with DIN EN ISO 29022, preferably DIN EN ISO 29022:2013, to be made and thus a reproducible statement to be made regarding the bond strength of a dental material on a first surface. Concurrently, material and thus costs related to the method are saved.

A force-locked clamping of the test body, in particular through the use of a clamping device and at least one fixation element, can be additionally required for tightness along the lower edge, provided the plane-parallel alignment in the scope of the invention alone does not yet attain tightness. This is no problem at all if the adjusting element for adjusting the height and/or inclination is used, which is in contrast to the use of cover glasses according to the prior art and DIN EN ISO 29022, preferably DIN EN ISO 29022:2013. Due to the nature of the material of the adjusting element, made from steel, stainless steel and/or alloys thereof, force-locked clamping of the test body under the shaped part is feasible without affecting the adjusting element, test body and/or first surface. In contrast, the use of cover glasses does not provide for force-locked clamping and/or connection between the lower edge of the sample well and the first surface, because the breaking strength of glass is low. Glass breakage during the method for producing an adhesive bond can lead to a shift of the position, in particular, of the first surface in the device and can thus lead to the formation of gaps between a first surface and the lower edge of the sample well of the shaped part and thus to leakage of the dental material and the generation of distortions. Moreover, said glass breakage can also affect the formation of the adhesive bond, during which interactions between a dental material and the first surface on an atomic and/or molecular level proceed, in particular during the curing process, whereby chemical and physico-chemical bonds already formed might be severed again. Said connections in an adhesive bond and/or on an adhesive surface include, in particular, hydrogen bridge bonds and covalent bonds between the functional groups which are known to a person skilled in the art from the prior art. The use of the adjusting element precludes the adverse effect on the formation of interactions and bonds between a first surface and at least one second surface, in particular of a dental material. In particular upon formation of an adhesive bond, in particular in a three-dimensional mold, between an adhering dental material, such as an adhesive, and a tooth surface, such as enamel and/or dentine, between an adhering dental material and a non-adhesive dental material, such as filling/cement materials and composites, or between a self-adhesive dental material, such as a composite, and a tooth surface, such as enamel and/or dentine. Preferably, the adhesive bonds described above are present as three-dimensional cylindrical shapes (FIGS. 5a to 5c).

Accordingly, another subject matter of the present invention is the use of an adjusting element in a device for producing at least one adhesive bond, in particular a device for producing an adhesive bond in accordance with DIN EN ISO 29022, preferably DIN EN ISO 29022:2013, on at least one contact surface (FIG. 3a), whereby an adhesive bond exists on the at least one contact surface between the first surface, in particular of a test body, and at least one second surface, in particular of a three-dimensional mold, whereby the at least one contact surface corresponds to the surface area that is bounded by a lower edge of the lower sample opening, an inner wall of a sample well of a shaped part, and a first surface that is arranged below the lower edge of the shaped part (FIGS. 3a to 3d and FIG. 4).

Preferably, having the boundaries leads to a flush and gap-free closure between the lower edge and the first surface such that tightness is attained, which prevents leakage of dental materials from the lower sample opening.

Preferably, the sample well of the shaped part comprises a cylindrical or angular geometry, in particular made up of four rectangular areas. The geometry of the sample well determines the spatial shape of the mold. Accordingly, the mold in the scope of the invention comprises any three-dimensional shape that is feasible based on the design of the sample well and/or is matching in shape and/or is a negative shape of a shaped part of a device. Preferably, the mold is cylindrical in shape. Accordingly, the contact surface between the first surface and at least one second surface comprises corresponding two-dimensional dimensions also.

The three-dimensional test body comprises the sample to be tested and/or at least one material to be tested. In this context, the test body can fully consist of a sample of material to be tested or the sample of material to be tested is embedded in another material, in particular in a material that can be cured by means of light or can be chemically polymerized. Preferably, the sample of material to be tested comprises a first surface in the scope of the invention, on which the adhesion of a dental material is tested and on which an adhesive bond is formed for this purpose. Preferably, the sample of material to be tested is a tooth surface, in particular a human tooth surface, and the first surface is particularly preferred to be enamel and/or dentine.

Another subject matter of the invention is a use of the at least one adjusting element in a device for producing an adhesive bond, in particular a device for producing an adhesive bond in accordance with DIN EN ISO 29022, whereby at least one adhesive bond is formed on the at least one contact surface between
a) the first surface, in particular the surface of a three-dimensional test body, which is selected from (1) natural and/or (2) synthetic dental surfaces, comprising
   (1) natural surfaces of the oral cavity of humans or animals, such as teeth, in particular mammalian teeth, such as bovine teeth, enamel, dentine, root cementum, and periodontal membrane as well as lower jaw and upper jaw bones from humans and animals, and/or
   (2) synthetic surfaces comprising prostheses, framework materials for bridges and crowns, implants, bone replacement materials, filling materials, root filling materials, and veneering materials each comprising materials selected from metal, heavy metal, titanium, alloys, in particular Au, Pt, Ag, Cu, Zn, In, Ir, Pd, Sn, Co, Cr, Ni, Mo, W, Mn, Fe, Si, N and/or Ru, cements comprising silicate cements, glass-ionomer cements (glass-polyalkenoate cements), light-curing cements and cermet cements, ceramic materials, zirconium oxide, glass, plastic materials, and combinations of at least two of the afore-mentioned materials, and
b) at least one second surface, selected from
   (1) self-adhesive dental materials comprising one- and two-component dental materials comprising self-adhesive dental polymers, self-adhesive composite materials, self-adhesive filling materials/filling plastics, self-adhesive veneering materials/veneering plastics, self-adhesive prosthesis plastic materials, self-adhesive stump build-ups and self-adhesive fissure sealants, in particular self-adhesive cement materials and/or
   (2) adhering dental materials comprising adhesives, adhesives for tooth-plastic bonding, adhesives for tooth-ceramic bonding, adhesives for tooth-metal bonding, adhesives for metal-plastic bonding, adhesives for metal-ceramic bonding, adhesives for ceramic-plastic bonding, adhesives for plastic-plastic bonding, adhesives for ceramic-ceramic bonding.

In an embodiment of the invention, the use according to the invention comprises at least one adhesive bond, according to an alternative (a), between the first surface and a second surface of a self-adhesive dental material in the form of a three-dimensional mold (FIG. 5a), or, according to an alternative (b), between the first surface and a second surface of an adhering dental material, in particular an adhesive, in the form of at least one intermediate layer (FIGS. 5b and 5c), in particular as adhesion promoter. It is preferably according to alternative (b) to have at least one second adhesive bond between the at least one intermediate layer and at least one non-adhesive dental material in the form of a three-dimensional mold present, whereby non-adhesive dental materials comprise one- and two-component dental materials comprising dental polymers, composite materials, filling materials/filling plastics, veneering materials/veneering plastics, cement, composite cements, silicate cements, glass-ionomer cements (glass-polyalkenoate cements), light-curing cements, cermet cement, stump build-ups, and fissure sealants. The non-adhesive dental materials each comprise at least one compound, in particular at least one polymerizable compound, preferably curable with light and/or chemically, containing (i) at least one methacrylate, acrylate, styrene and/or vinyl group, and/or (ii) at least one acid-functional group selected from phosphoric acid, phosphinic acid, phosphonic acid, sulfuric acid, sulfonic acid, sulfinic acid, and carboxylic acid group, and/or (iii) at least one resin or other compounds having at least one unsaturated ethylenic group as well as the corresponding derivatives of afore-mentioned compounds (i), (ii) and (iii), (in particular anhydrides, esters), and/or (iv) at least one component based on glass and/or at least one ion-releasing compounds. Mono-, di-, and multifunctional polymerizable compounds are preferred monomers. UDMA, Bis-GA, TCD, TEGDMA, EGDMA, HDDMA are particularly preferred di-functional monomers, and HEMA, HPMA, MMA are particularly preferred mono-functional monomers.

The at least one intermediate layer comprises at least one adhering dental material, which also include primers, self-etching primers, ceramic primers, metal primers, in particular light-curing primers. Said primers are needed, in particular, during the use of composite or cement materials, in particular non-adhesive materials, in order to attain good adhesion on a first surface, such as enamel and/or dentine. In a special embodiment, at least two intermediate layers are present, whereby the first intermediate layer contains a primer and the second intermediate layer contains an adhesive (bond). In particular, two intermediate layers are used for promotion of adhesion of a composite or cement material on a first surface. Said embodiment comprises, in particular, the arrangement of first surface/primer/adhering dental material (adhesive)/non-adhesive dental material.

Preferably, the first surface is present in the form of a test body. It is particularly preferred for the first surface to be an enamel and/or a dentine surface of a human or animal tooth, whereby same is embedded in a polymerizable material, preferably acrylate-based embedding material, with an embedding material approved in accordance with DIN EN ISO 29022 being particularly preferred. Referring to the human denture, the molar teeth (grinders) are preferred, the third molar is particularly preferred. Referring to the animal denture, preferably bovine denture, the incisor is preferred. The test body is produced according to the methods known according to the prior art, in particular the method described in DIN EN ISO 29022.

Another subject matter of the invention is a device (FIG. 2 and FIG. 4) of the afore-mentioned type comprising a) a clamping device for fixation of at least one first surface and b) at least one adjusting element (FIGS. 1a to 1g) for alignment of the height and/or inclination of a first surface, in particular of a test body, into a plane-parallel position of the first surface with respect to at least one contact surface (FIG. 4), in particular with respect to the lower edge of a sample well of a shaped part. Whereby, after alignment, in particular an angle beta of 90° between the inner wall of a sample well and/or the central axis M of the mold and a first surface is attained (FIG. 3a).

In a special embodiment, the first surface, in particular the dentine and/or enamel surface of a tooth, is already coated with an adhering dental material, such as an adhesive described above. Accordingly, the application of an adhering dental material, in particular in the form of at least one intermediate layer, in the scope of the invention can proceed even before the introduction of the test body into the device as described. Alternatively, the application of the adhesive can also proceed after the test body having the first surface has been positioned in the device as described above.

The contact surface between the first surface and the second surface of the three-dimensional mold corresponds to the diameter of the three-dimensional mold (FIG. 3a, FIGS. 5a to 5c).

The contact surface is defined by the surface which is bounded by an inner wall of a lower edge of a lower sample opening of a shaped part and by the first surface arranged below the lower edge of the shaped part (FIGS. 3a to 3d and FIG. 4).

Another subject matter of the invention is a device for producing at least one adhesive bond on at least one contact surface between a first surface, in particular of a test body, and at least one second surface, in particular of a mold comprising a dental material, preferably for producing an adhesive bond in accordance with DIN EN ISO 29022, comprising
a clamping device for fixation of at least the first surface, in particular of the test body which in particular can be inserted into the clamping device, whereby preferably at least one fixation element for fixation is present;
a shaped part comprising an upper sample opening for introducing and positioning of a dental material, in particular an adhering dental material, a self-adhesive dental material and/or a non-adhesive dental material, in the preferably cylindrical sample well onto the first surface, in particular onto a first surface which is already coated with an adhering dental material, such as an adhesive;
at least one adjusting element for alignment of the height and/or inclination (FIGS. 1a to 1g) of a first surface into a plane-parallel position with respect to at least one contact surface and/or with respect to the lower edge of the shaped part (FIG. 3a and FIG. 4). Preferably, at an angle beta of 90° between the inner wall of a sample well and/or the central axis M of the mold and the first surface (FIG. 3 and FIG. 5).

In particular, the first surface or the contact surface can be aligned according to the opposite contact surface or first surface, in particular through the use of the device comprising an adjusting element and a shaped part. Accordingly, the first surface can be aligned according to the contact surface or the contact surface, in particular the shaped part, is aligned into a plane-parallel position with respect to the first surface. In the former case, the first surface is positioned, in detachable manner, or is affixed and/or installed on the adjusting element, as has already been described above, and in the latter case the shaped part is aligned with respect to the first surface by means of the adjusting element. In this context, the shaped part is installed fixedly on the test body floor space of the adjusting element, comprising at least one angle-adjustable component, and the adjusting element is clamped into a clamping device by means of at least one fixation device, whereby the lower sample opening of the sample well is aligned with respect to the first surface of a test body arranged below the sample well. Optionally, an adjusting element having at least one height-adjustable component can be arranged below the test body in order to overcome a potential height difference. This also provides for a plane-parallel position of the first surface with respect to the lower edge of the shaped part such that a defined and reproducible contact surface and thus a defined and reproducible adhesive surface in the adhesive bond are attained, as before. Accordingly, when the dental material, in particular an adhering, self-adhesive or non-adhesive dental material, is introduced into the sample well of the shaped part, there is no leakage of material, since there is no gap between first surface and the lower edge of the shaped part, in particular the contact surface. This ensures a reproducible measurement of the force per unit area, which is identical to the contact surface of the tested adhesive bond as obtained according to an alternative (a) or (b) as shown in FIG. 5a and FIG. 5b.

Another subject matter of the present invention is a shaped part that surrounds a test body in shape-matching manner (see FIGS. 3b and 3c) such that the use of an adjusting element in the scope of the invention is not mandatory. In this refinement, the outer diameter of the outer edge of the shaped part, which preferably is circular in design, is identical to the outer diameter of the shaped part such that the outer boundary comprises no steps and/or edges towards the upper side. Moreover, the length of the outer edge, originating from the upper side, is longer than the depth of the sample well and projects from a common upper side beyond the lower edge. The test body, with its first surface being arranged below it, is surrounded by the projecting outer edge (FIGS. 3b and 3c) such that there is no gap between the lower edge and the first surface and, accordingly, no dental material can leak and no distortions can arise. If needed, said refinement can comprise, in addition, at least one support, as shown in FIG. 3c, which can be designed in the form of a foot or ring extending around the sample well. In a special refinement, the shaped part comprises a mobile outer edge with a variable diameter such that said diameter can be adapted to the outer diameter of a test body (not shown). In a special embodiment of the shaped part, the sample well is flexibly mobile along the horizontal plane (arrows in FIG. 3b) such that the sample well can be positioned in central position above the first surface, in particular dentine and/or enamel of a tooth. In this context, the shape and geometry of the contact surface remain unchanged. Only its position is variable. In order to fix the desired position on the first surface, suitable fixation elements are provided (not shown). Said design of the shaped part can be of advantage for circumferential flexibility in case no more complex device is being used. By this means, the shaped part can be positioned flexibly and in shape-matching manner with respect to the test body and also without any gap with respect to the first surface such that no dental material can leak and no distortions can arise.

Using a shaped part of any of the types described above precludes the formation of gaps between a first surface and the lower edge of a shaped part. Due to the fit being flush and preferably tight, a defined and reproducible contact surface is attained, such that no not-yet-cured dental material leaks from the sample well and the formation of distortions is precluded. By this means, defined and reproducible adhesive surfaces in the adhesive bond are always obtained and thus a reproducible determination of the adhesion of a dental material on a first surface is attained, preferably on a tooth surface comprising enamel and/or dentine, preferably by measurement of the shear bond strength, in particular in accordance with DIN EN ISO 29022. This allows reproducible and reliable information about the bond strength of an adhering dental material or self-adhesive dental material to be obtained. Concurrently, since distortions are precluded and there is no polishing process as required according to the prior art, materials and costs are saved in the method.

As a further subject matter of the present invention, a preferred embodiment of the device described above comprises at least one adjusting element having the following components (see FIGS. 1a to 1g):
i) a lower base that is plane-parallel to a plane E;
ii) a height-adjustable component arranged above the base, which can be set up, in particular, on a working surface, in particular a floor space of a clamping device, to be plane-parallel and which can be adjusted in a range from more than or equal to 0 mm, in particular to less than or equal to 100 mm, preferably in a range from more than or equal to 0 mm to less than or equal to 100 mm, from more than or equal to 4 mm to less than or equal to 100 mm, from more than or equal to 4 mm to less than or equal to 80 mm, from more than or equal to 4 mm to less than or equal to 70 mm, from more than or equal to 4 mm to less than or equal to 60 mm, from more than or equal to 4 mm to less than or equal to 50 mm, from more than or equal to 4 mm to less than or equal to 40 mm, and/or
iii) an angle-adjustable component arranged on said component, which preferably comprises a ball-shaped element that can be adjusted to an angle alpha (shown in FIG. 1a in exemplary manner) between a plane E and a plane Eₐₗₚₕₐ, whereby plane E of the test body floor space corresponds to a position that is plane-parallel with respect to the base, and plane Eₐₗₚₕₐ corresponds to the inclined test body floor space that touches against the underside of the test body. The angle alpha can be adjusted in a range from more than or equal to 0° angular minutes, in particular to less than or equal to 60° degrees, step-less or in steps. Preferably, in a range from more than or equal to 0° to less than or equal to 50°, from more than or equal to 0° to less than or equal to 45°, from more than or equal to 0° to less than or equal to 40°, from more than or equal to 0° to less than or equal to 35°, from more than or equal to 0° to less than or equal to 30°, particularly preferably from more than or equal to 0° to less than or equal to 25°. In particular, the angle alpha can be varied in small steps (1°=60′ angular minutes) of more than or equal to 0′, 6′, 12′, 24′, 30′, 36′, 42′, 48′, 54′, and to less than or equal to 60′ angular minutes and minute inclinations of less than or equal to 1° degree, preferably of less than or equal to 60′, 54′, 48′, 42′, 36′, 30′, 24′, 12′, to less than or equal to 6′ angular minutes can be fine-adjusted. In particular, step-wise adjustment of angle alpha in a range from more than or equal to 0° to less than or equal to 10° in angular minutes [′] steps of 30′ is preferred, and
iv) an upper test body floor space, which corresponds, in particular, to the upper side of the component and has a diameter Dₐ, which preferably corresponds to the diameter of the test body, in particular to the diameter of the underside of the test body.
v) Optionally, the at least one adjusting element comprises at least one locking device for fixing the position of the adjusted height and/or inclination of the adjusting element, whereby the locking device is a screw, lock nut or any other device for blocking all degrees of freedom of the adjusting element, and
vi) optionally, at least one fixation element that is combined with the base, in particular a fixedly connected or detachably combinable fixation element for attachment of the adjusting element in a device, in particular in a clamping device of a device, wherein the fixation element is a screw, lock nut or any other device for blocking all degrees of freedom of the arrangement, as shown in FIG. 2, FIG. 4, and FIG. 7c.

Preferably, the adjusting element comprises a height-adjustable component and an angle-adjustable component, preferably a ball-shaped element. Preferably, the test body floor space has a circular geometry and a diameter designed appropriately such that the test body can be set up securely without tipping. Preferably, the entire underside of the test body stands on the test body floor space, as is shown in FIG. 7c in exemplary manner. In some refinements of the test body floor space, the diameter is more than or equal to 0.5 cm to less than or equal to 10 cm, preferably more than or equal to 0.8 cm to less than or equal to 8 cm, more than or equal to 1.0 cm to less than or equal to 6 cm, more than or equal to 2.0 cm to less than or equal to 8 cm, more than or equal to 2.5 cm to less than or equal to 6.0 cm.

In a preferred embodiment, the device described above comprises at least one adjusting element that is attached in non-detachable manner on a working surface, in particular through its base on the floor space of a clamping device, preferably by means of at least one fixation element, or is positioned in detachable manner on a working surface of a device or measuring facility (FIG. 4), in particular on a floor space. Preferably, the fixation elements of the at least one adjusting element can be lowered into the floor space of the clamping device in order to obtain a level and stable underside of the entire device.

Preferably, the underside of the test body contacts the test body floor space of the adjusting element in the device according to the invention, preferably in a device for producing an adhesive bond between a first surface, in particular a tooth surface comprising enamel and/or dentine, in particular in a device in accordance with DIN EN ISO 29022.

Preferably, the device according to the invention, in particular in accordance with DIN EN ISO 29022, comprises a clamping facility having at least one fixation element, preferably screws and/or nuts, for fixing test body between the at least one adjusting element and the shaped part and/or an adjusting element having at least one locking device for fixing the adjusting element on the floor space.

In a preferred embodiment of the device according to the invention for producing an adhesive bond between a first surface, in particular a tooth surface comprising enamel and/or dentine, in particular in a device in accordance with DIN EN ISO 29022, the adjusting element is not detachable. In particular, the adjusting element, which is situated on the floor space of the clamping device in non-detachable manner and/or is positioned on its base in detachable manner, preferably locked by means of at least one locking device, and the test body, which contacts the test body floor space of the adjusting element through its underside, is not detachable for the duration of a method for producing at least one adhesive bond, in particular not during the curing process of a dental material, in particular not during the polymerization of a dental material and adhesion of the dental material to the first surface. Preferably, the device as described above is not detachable for the duration of the curing, in particular during the polymerization of the adhering dental material and adhesion of the material to the first surface in a device and a method in accordance with DIN EN ISO 29022. If the afore-described arrangement is connected in force-locked manner, shocks cannot have an adverse effect on the process of adhesion due to shifts of the individual elements of the device. As a result, reproducible adhesive surfaces are attained, which preferably coincide with the contact surface between a first surface and at least one second surface comprising the at least one dental material.

A reproducible adhesive bond produced as described above through the use of an adjusting element in a device has a positive effect on the second part of the whole method, as described above. The second part of the method relates to the measurement of the adhesion and/or shear bond strength. A device for exertion of a traction force, thrust force and/or shearing force is used in said methods and comprises a force-exerting shaped part that borders the three-dimensional mold along the longitudinal axis M (see FIG. 5), as shown in FIG. 6, at least partly in shape-matching manner without direct contact and directly contacts the outer surface of the mold only by means of a minimal force surface and/or contact surface.

Another subject matter of the present invention is a method for producing at least one adhesive bond on a contact surface, in particular on a defined and reproducible contact surface, between a first surface, in particular of a test body, and at least one second surface, in particular of a mold, in particular a method for producing at least one adhesive bond in accordance with DIN EN ISO 29022, preferably DIN EN ISO 29022:2013, comprising the steps of
a) positioning a test body by its underside, comprising the first surface, preferably a dentine and/or enamel surface of a tooth, on the test body floor space of an adjusting element, whereby (i) the adjusting element is introduced into the device first and then the test body is placed on the test body floor space by its away side, or (ii) the test body is placed on the floor space by its away side first and then the adjusting element is introduced between test body and floor space, or (iii) the test body is placed by its away side on the test body floor space of the adjusting element outside of the clamping device first;
b) aligning the first surface, in particular of the test body, into a plane-parallel position with respect to the contact surface, in particular with respect to the lower edge of a shaped part, and at an angle beta of 90° with respect to the inner wall of a sample well of the shaped part, whereby (i) the alignment according to (i) and (ii) is done in the clamping device or (ii) the alignment according to a) (iii) is done outside of the clamping device;
c) contacting the first surface, in particular of a test body, to the lower edge of the lower sample opening of a shaped part, whereby the lower edge is flush, preferably without gaps, with the first surface, and obtaining a defined marked-off contact surface (FIG. 3a);
d) introducing a dental material through the upper sample opening into the sample well, preferably into the cylindrical sample well, of the shaped part and, in particular, onto the first surface such that not yet cured self-adhesive or non-adhesive dental material contacts the first surface, which is optionally already coated with an adhering dental material, at the contact surface and covers it completely;
e) forming at least one adhesive bond at the contact surface between the first surface and at least one second surface of a dental material, whereby the not-yet-cured dental material adheres to the first surface, which is optionally coated with an adhering dental material, and then cures, whereby the second surface becomes connected to the first surface at the adhesive surface; and
f) obtaining an adhesive bond in the form of a three-dimensional mold according to an alternative (a) or an alternative (b).

Alternatively, step c) can precede step b), whereby, if an oblique and/or inclined position is present, an alignment of the first surface into a plane-parallel position with respect to the contact surface and at an angle beta of 90° with respect to the inner wall of a sample well of the shaped part is done until the first surface is flush with the lower edge of the lower sample opening of the shaped part.

In a preferred embodiment of the method, the alignment (b) of the first surface of the test body is done according to the invention through at least one adjusting element through adjusting the height and/or inclination of the adjusting element with respect to the contact surface and the lower edge of the shaped part into a plane-parallel arrangement of the surfaces with respect to each other and at an angle beta of 90° with respect to the inner wall of the sample well, whereby
i) the angle alpha can be adjusted in a range from more than or equal to 0′ angular minutes, in particular to less than or equal to 60° between a plane E of the adjusting element and the underside of the test body, in particular a planeₐₗₚₕₐ, as is shown in exemplary manner in FIG. 1a, and/or
ii) the height can be adjusted in a range from more than or equal to 0 mm, in particular to less than or equal to 100 mm, and
   then, optionally, locking of the adjusted position by means of at least one locking device and fixation of the set-up described above by means of at least one fixation element on a working surface, preferably a floor space of a clamping device.

The shaped part can be attached in the clamping device in the method either before or after b) alignment of the first surface of a test body. In an embodiment of the method in the scope of the invention, the shaped part is applied onto the test body before or after b) alignment of the first surface, whereby the shaped part is designed appropriately such that the outer edge has an inner diameter that corresponds to the outer diameter of the test body, and the test body is surrounded by the outer edge at the outer wall in flush manner (see FIGS. 3b and 3c). In particular, the first surface can be fixed in the selected position through at least one locking device after the alignment is done and before applying the shaped part. If required, the adjusting element can be attached at a working surface by means of at least one fixation element in particular on a floor space of a clamping device.

In a special refinement of the method, c) a defined contact surface (FIG. 3a) is obtained upon the contacting, whereby the inner wall of a sample well and the lower edge of the lower sample opening of a sample well are flush and free of gaps with respect to a first surface, in particular a first surface of a test body already coated with an adhesive. In this context, the shaped part rests on the test body at least by its lower edge of the sample well (see FIG. 3a) and the first surface concurrently is surrounded by the lower edge as its boundary, whereby the first surface is arranged within the sample opening and forms the floor of the sample opening (see FIG. 3a and FIG. 3c). By this means, a defined contact surface is obtained that corresponds to the adhesive surface of the adhesive bond between a first surface, preferably an enamel and/or dentine surface, and a second surface comprising a dental material, in particular an adhering, self-adhesive and/or non-adhesive dental material.

Optionally, the first surface is already coated with an adhering dental material, before applying a non-adhesive dental material. Moreover, a completely closed-off contact surface is thus obtained, whereby the lower edge resists on the test body by its entire circumference and thus prevents a dental material from leaking. As a result, the formation of distortions is precluded and, ultimately, reproducible measuring values in force per unit area, being equal to the adhesive surface, are obtained in a method for determination of the adhesion of at least one dental material, in particular of the shear bond strength in accordance with DIN EN ISO 29022.

Thus another subject matter of the invention is an adhesive bond between the first surface and the second surface, as both described herein, having a defined contact surface as described above and obtainable by the herein described.

Preferably, prior to d) the introduction of a dental material, the arrangement described above, as shown in FIG. 2, FIG. 4, and FIG. 7c, comprising the test body below the shaped part and the adjusting element below the mold, is fixed in place in the clamping device through at least one fixation element. The fixation is to proceed until, in particular, tightness is attained at the contact surface between the first surface and the lower edge of the sample well, provided said tightness is not attained already through the plane-parallel alignment, in order to prevent a dental material from leaking.

Steps d), e), and f) vary as a function of the desired arrangement (FIGS. 5a to 5c) and/or design of the three-dimensional mold, in particular comprising at least one adhesive bond. It is therefore preferred in step d) of the method described above to introduce at least one self-adhesive dental material into the sample well onto a first surface and f) to obtain an adhesive bond according to alternative (a) (FIG. 5a) or to apply, in step d), at least one non-adhesive dental material into the sample well onto at least one intermediary layer containing at least one adhering dental material, whereby the at least one intermediate layer adheres to the first surface and f) an adhesive bond according to an alternative (b) is obtained (FIGS. 5b and 5c).

In order to obtain an adhesive bond according to an alternative (a) (see FIG. 5a), as described above, d) a self-adhesive dental material is applied onto the first surface, preferably enamel and/or dentine, whereby self-adhesive dental materials comprise one- and two-component dental materials comprising self-adhesive dental polymers, self-adhesive composite materials, self-adhesive filling materials/filling plastics, self-adhesive veneering materials/veneering plastics, self-adhesive prosthesis plastic materials, self-adhesive stump build-ups, self-adhesive cements, and self-adhesive fissure sealants. Subsequently, e) an adhesive bond is formed at the contact surface between the first surface and the self-adhesive dental material, whereby the not-yet-cured self-adhesive dental material adheres to the first surface and is cured subsequently or concurrently, whereby the second surface of the self-adhesive dental material becomes connected to the first surface at the adhesive surface and thus f) an adhesive bond in the form of a three-dimensional mold according to an alternative (a) is obtained (FIG. 5a).

In order to obtain an adhesive bond according to an alternative (b) (see FIG. 5b and FIG. 5c), firstly an adhering dental material is applied onto the first surface, whereby adhering dental materials comprise adhesives, adhesives for tooth-plastic bonding, adhesives for tooth-ceramic bonding, adhesives for tooth-metal bonding, adhesives for metal-plastic bonding, adhesives for metal-ceramic bonding, adhesives for ceramic-plastic bonding, adhesives for plastic-plastic bonding, adhesives for ceramic-ceramic bonding. This step can proceed either as early as before step a) or as late as in step d), whereby a first adhesive bond between the first surface and the adhering dental material is formed in either case. An extended intermediate layer is obtained in the first variant, as shown in FIG. 5c, and at least one intermediate layer that coincides with the contact surface is obtained in the second variant, as shown in FIG. 5b. Then, steps a) to c) are carried out in the first variant, as described above. In both variants follows, as the next step, d) the introduction of at least one non-adhesive dental material onto the adhering, already cured dental material in the form of at least one intermediate layer. Non-adhesive dental materials comprise one- and two-component dental materials comprising dental polymers, composite materials, filling materials/filling plastics, veneering materials/veneering plastics, cements, composite cements, silicate cements, glass-ionomer cements (glass-polyalkenoate cements), light-curing cements, cermet cements, stump build-ups, and fissure sealants. In a next step e), the second adhesive bond between the at least one intermediate layer of an adhering dental material, in particular adhesive, and at least one non-adhesive dental material is formed and thus f) an adhesive bond is obtained in the form of a three-dimensional mold according to an alternative (b). In said adhesive bond, the intermediate layer adheres to the first surface by means of an inner surface and adheres to the non-adhesive dental material by means of another inner surface, in particular through an inner surface opposite from the first inner surface, to the adhesive dental material. Specifically, the at least one intermediate layer is an adhesion promoter between the first surface and a dental material, in particular a non-adhesive dental material.

It is preferred in the method according to the invention to have, in step d), the contact surface thus obtained be covered, preferably fully, at least by the dental material and to have the sample well filled with the dental material, in particular the self-adhesive or non-adhesive dental material, maximally up to the upper edge. A defined amount of the dental material is introduced in this context, whereby the consumed amount is reproducible since no dental material can leak as there are no gaps between the lower edge and the first surface. The method according to the invention attains not only at least one reproducible adhesive surface and thus a reproducible measurement of the force per unit area of the adhesive bond according to alternative (a) or (b), but also a significantly reduced consumption of material. Moreover, the method according to the invention affords a definition of the requisite volume of the dental material used in the individual case as a function of the size and volume of a sample well of a shaped part. This enables a reliable calculation of the costs of the method and easy implementation of the method.

According to the invention, e) an adhesive bond, in particular according to alternative (a) or (b) is formed in the method essentially at the contact surface, and a three-dimensional mold is obtained after curing, preferably light-mediated polymerization, of the dental material and removal of the shaped part (FIGS. 5a to 5c). The cured three-dimensional mold having the at least one adhesive bond essentially at the defined contact surface, obtainable by the methods as described above, is a further object of the invention. In order to save material, in particular adhering dental material, and to obtain a defined adhesive surface of the adhering dental material in the form of at least one intermediate layer with respect to the first surface, an adhesive bond according to an alternative (b), as shown schematically in FIG. 5b, is preferred. In particular, the geometry of the mold corresponds to the negative shape of the sample well of a shaped part (see FIGS. 3a-3c and FIGS. 5a, 5b, and 5c). Preferably, the geometry of the mold is adapted to the geometry of a shaped part of a device or the shaped part is matched to the geometry of the mold. In a method for measuring the adhesion of a dental material on a first surface, optimal positioning of the shaped part can be attained by this means.

Therefore, another subject matter of the invention is a method for determining the adhesive strength of at least one dental material on a first surface in an adhesive bond, in particular an adhesive bond according to an alternative (a) or (b), whereby said adhesive bond is present at the contact surface between the first surface and at least one second surface and the contact surface corresponds to the surface, which has a lower edge of the lower sample opening, an inner wall of a sample well of a shaped part, and the first surface, which is arranged below the lower edge of the shaped part, for its boundaries (FIG. 3a) and can be obtained according to the method according to the invention described above through the use of the device, comprising the steps of
a) clamping a three-dimensional mold, in particular a mold adhering on a first surface, in particular according to an alternative (a) or (b), into a device comprising a shaped part for exertion of a force;
b) exerting a shearing force, thrust force, and/or traction force onto at least one adhesive bond at the contact surface; and
c) measuring the shearing force, thrust force, and/or traction force applied at the time the at least one adhesive bond breaks.

It is preferable in the method described above that a) the shaped part surrounds the three-dimensional mold along its longitudinal axis at least partially in shape-matching manner without directly contacting the outer surface, and that b) the force is exerted essentially through the shaped part at a minimal force surface and/or contact surface at the outer surface of the mold, whereby the shaped part touches the mold only at said contact surface as close as possible to the contact surface, preferably directly at the contact surface, and that c) the bond strength of the adhesive bond, in particular according to an alternative (a) or (b), is measured in units of force per contact surface area, as described above.

In the method for determining the bond strength of at least one dental material at a first surface, preferably a method for measuring the shear bond strength and/or bond strength in accordance with DIN EN ISO 29022, preferably DIN EN ISO 29022:2013, the adhesion in at least one adhesive bond, in particular according to an alternative (a) or (b), between a first surface and at least one second surface or in an adhesive bond between a first surface and an intermediate layer and an intermediate layer and at least one second surface is tested, whereby
a) the first surface is selected from (1) natural and/or (2) synthetic dental surfaces, comprising
   (1) natural surfaces of the oral cavity of humans or animals, such as teeth, in particular mammalian teeth, such as bovine teeth, enamel (tooth enamel), dentine, root cement, and periodontal membrane as well as lower jaw and upper jaw bones from humans and animals, and/or
   (2) synthetic surfaces comprising prostheses, framework materials for bridges and crowns, implants, bone replacement materials, filling materials, root filling materials, and veneering materials each comprising materials selected from metal, heavy metal, titanium, alloys, in particular Au, Pt, Ag, Cu, Zn, In, Ir, Pd, Sn, Co, Cr, Ni, Mo, W, Mn, Fe, Si, N and/or Ru, cements comprising silicate cements, glass-ionomer cements (glass-polyalkenoate cements), light-curing cements and cermet cements, ceramic materials, zirconium oxide, glass, plastic materials, and combinations of at least two of the afore-mentioned materials, and
b) at least one second surface for an adhesive bond according to an alternative (a) (FIG. 5a) is selected from
   (1) self-adhesive dental materials comprising one- and two-component dental materials comprising self-adhesive dental polymers, self-adhesive composite materials, self-adhesive filling materials/filling plastics, self-adhesive veneering materials/veneering plastics, self-adhesive prosthesis plastic materials, self-adhesive stump build-ups, self-adhesive fissure sealants, and self-adhesive cement materials, acid-modified glass-ionomer cements, and/or
   (2) adhering dental materials comprising adhesives, adhesives for tooth-plastic bonding, adhesives for tooth-ceramic bonding, adhesives for tooth-metal bonding, adhesives for metal-plastic bonding, adhesives for metal-ceramic bonding, adhesives for ceramic-plastic bonding, adhesives for plastic-plastic bonding, adhesives for ceramic-ceramic bonding, or
   at least one second surface for an adhesive bond according to an alternative (b) (FIGS. 5b and 5c) is selected from
   (3) non-adhesive dental materials comprising one- and two-component dental materials comprising dental polymers, composite materials, filling materials/filling plastics, veneering materials/veneering plastics, cement, composite cements, silicate cements, glass-ionomer cements (glass-polyalkenoate cements), light-curing cements, cermet cement, stump build-ups, and fissure sealants, whereby the at least second surface is present on at least one adhering dental material in the form of at least one intermediate layer.

Another subject matter of the present invention is a method for producing an adhesive bond and a method for determining the shear bond strength, each in accordance with DIN EN ISO 29022, in compliance with the standards defined therein.

Another subject matter of the invention is the use of the device according to the invention for producing at least one adhesive bond at at least one contact surface between a first surface and at least one second surface, comprising a dental material, for producing a three-dimensional mold comprising at least one adhesive bond between a first surface and at least one second surface, for producing an adhesive bond in accordance with DIN EN ISO 29022, for producing a three-dimensional mold comprising at least one adhesive bond in accordance with DIN EN ISO 29022, for producing an adhesive bond for use in a method for determining the force to be exerted to separate or break the at least one adhesive bond, and the use of an adhesive bond according to the invention, in particular according to an alternative (a) or (b), in a method for measuring the bond strength of an adhering dental material or of a self-adhesive dental material on a first surface, in particular dentine or enamel, and in a method for determining the shear bond strength in accordance with DIN EN ISO 29022.

The figures show schematic views of the invention and illustrate them in more detail without limiting the invention to the views presented in the figures.

### DESCRIPTION OF THE FIGURES

FIGS. 1a) to 5g) illustrates an adjusting element 10 and embodiments of the adjusting element 10

FIG. 1a) shows a cross-section of an adjusting element 10 having a test body floor space 14, an angle-adjustable component 13 as ball-shaped compensation element 13 and a base 11; the adjustable angle alpha between virtual plane E and plane Eₐₗₚₕₐ and the height shift resulting from angle alpha are indicated by arrows.

FIG. 1b) shows a cross-section of an adjusting element 10 having a test body floor space 14, an upper angle-adjustable component 13 and a height-adjustable component 12 arranged below it on a base 11; the adjustable angle alpha at plane E and the lowest height H as well as the maximal height Hₘₐₓ of the height-adjustable component 12 are indicated by arrows.

FIG. 1c) shows a cross-section of an adjusting element 10 having a test body floor space 14 and a height-adjustable component 12 on a base 11; both the lowest height (H) as well as the maximal height (Hₘₐₓ) are shown.

FIG. 1d) shows a top view of a test body floor space 14 of an adjusting element 10 having an outer diameter D_{A}.

FIG. 1e) shows a cross-section of an adjusting element 10 having a ball-shaped compensating element for the angle-adjustable component 13 and at least one fixation element 16 for attaching an adjusting element 10 in/on a device for producing an adhesive bond 20 and/or clamping device 30; the adjusting element is positioned, by its base 11 and the at least one fixation element, on a floor space 32 of a device 20 for producing an adhesive bond and/or clamping device 30.

FIG. 1f) shows a cross-section of an adjusting element 10 having a test body floor space 14, a height-adjustable component 12 as well as at least one outer locking device 15 for fixation of the adjusted height of the adjusting element 10; both the lowest height (H) as well as the maximal height (Hₘₐₓ) are shown.

FIG. 1g) shows a cross-section of an arrangement comprising a test body 60, which is positioned, by its underside 62, on the test body floor space 14 of an adjusting element 10, whereby the inclination of the test body 60 along a plane E is compensated through the angle-adjustable component 13 through an angle alpha, and a height-adjustable component 12 that is arranged below the angle-adjustable component 13 as well as at least one outer locking device for fixation of the adjusted angle and height of the adjusting element 10, whereby the adjusting element 10 is positioned, by its base 11, on a working surface 32 of a device 20 for producing an adhesive bond and/or clamping device 31.

FIG. 2 shows an arrangement of a device 20 for producing an adhesive bond, comprising the following components: a clamping device 30 having two fixation elements 31, in particular nuts, a test body 60, whose underside 62 is aligned towards the test body floor space 14 of an adjusting element 10 that is arranged on the floor space 32 of a clamping device 30; a shaped part 40 is arranged above a first surface 61, which concurrently is the upper side of the test body 60, whereby the lower sample opening 41 of the sample well 46 of the shaped part 40 is aligned towards the first surface 61 and the upper sample opening 43 is aligned towards the upper part of the clamping device 30.

FIG. 3a shows a detailed cross-section of a shaped part 40 arranged above a test body 60, comprising a sample well 46 for accommodation of a dental material 70 via the upper sample opening 43, having an inner wall 45 and a lower sample opening 41, that is distinct from the lower edge 42 as well as an outer edge 44 of the shaped part 40; upon the use of said shaped part, the lower edge 42 contacts the first surface 61 of a test body 60 and the outer edge 44 rests on the test body 60 within the diameter of the test body 60, in particular on the embedding material 67.

FIG. 3b shows a detailed cross-section of a shaped part 40 as in FIG. 3a, whereby the outer edge 44 in the present embodiment concurrently is the outer ledge of the shaped part 40 and the outer edge 44, originating from the upper side 48 of the shaped part 40, is longer than the depth of the sample well 46. In this embodiment, the outer edge 44 does not rest on the test body 60, but it surrounds the test body 60, as shown in FIG. 3c.

FIG. 3c shows a detailed cross-section of a shaped part 40, as shown in FIG. 3b, whereby, in addition, at least one support 47 is present for stabilization of the position of the shaped part 40 on a test body 60.

FIG. 4 shows a cross-section of a clamped device 20 having an analogous design as shown in FIG. 2, whereby the inclination of a test body 60 and the first surface 61, analogous to FIG. 1 g), has been aligned on a plane E to be plane-parallel to the lower edge 42 of the shaped part 40 by means of an adjusting element 10, whereby the adjusting element 10 has been fixed in place by means of the fixation elements 16 and the entire arrangement as described above has been fixed in place on a floor space 32 by means of the fixation elements 31.

FIG. 5a shows a perspective view of an adhesive bond according to an alternative (a), in which the three-dimensional mold 71 comprises an adhering dental material 70 or a self-adhesive dental material 70 that forms, at the contact surface 21, the at least one second surface 72, which contacts the first surface 61, in particular enamel and/or dentine. After curing of the adhesive dental material or self-adhesive dental material 70, no distortions are present in the adhesive bond according to the invention.

FIG. 5b shows a perspective view of an adhesive bond according to an alternative (b), in which the three-dimensional mold 71 comprises a non-adhesive dental material 70 and an intermediate layer 90, whereby the intermediate layer 90 contacts the first surface 61 at the contact surface 21 and is connected to the at least second surface 72 of a non-adhesive dental material at its surface that faces away from the contact surface 21. In this embodiment, the adhering dental material 70 was introduced into the shaped part 40 after alignment of the test body in the device 20 and thus the intermediate layer coincides with the contact surface 21. After curing of the adhering dental material and non-adhesive dental material 70, no distortions are present in the adhesive bond according to the invention.

FIG. 5c corresponds to FIG. 5b, whereby the adhering dental material 70 in the present embodiment was applied already onto the first surface 61 before alignment of the test body in the device 20 and was then aligned below the shaped part 40. As a result, the intermediate layer 90 projects beyond the contact surface 21, whereby there are no distortions, as before, after curing of the non-adhesive dental material 70.

FIG. 6 shows a cross-section of an arrangement, in which the mold 71 adhering to the first surface 61 is clamped into a device 50 for exertion of a force onto the adhesive bond at the contact surface 21, whereby the first surface 61 is the surface of a tooth 64, in particular the dentine surface 66 underneath the enamel 65, embedded into a test body 60, and whereby the device 50 is arranged along the outer surface 73 of the mold 71 to be matching-in-shape with the shaped part 51 and contacts the mold 71 at the force surface and/or contact surface 74.

FIG. 7a) shows a test body 60 that comprises an oblique underside 62.

FIG. 7b) shows a perspective side view of a device for producing an adhesive bond according to the prior art, in which, after fixation of the non-plane-parallel test body 60, a gap 80 arises between the first surface 61 of a test body 60 and the lower edge 42 of the sample well 46 of a shaped part 40.

FIG. 7c) shows a test body 60 having an oblique underside 62 aligned according to the invention such as to be plane-parallel, positioned on the test body floor space 14 of an adjusting element 10, whereby the first surface 61 is aligned to be plane-parallel with respect to the lower edge 42 and the outer edge 44 and contacts the shaped part such as to be flush without a gap existing between the lower sample opening 41 and the first surface 61.

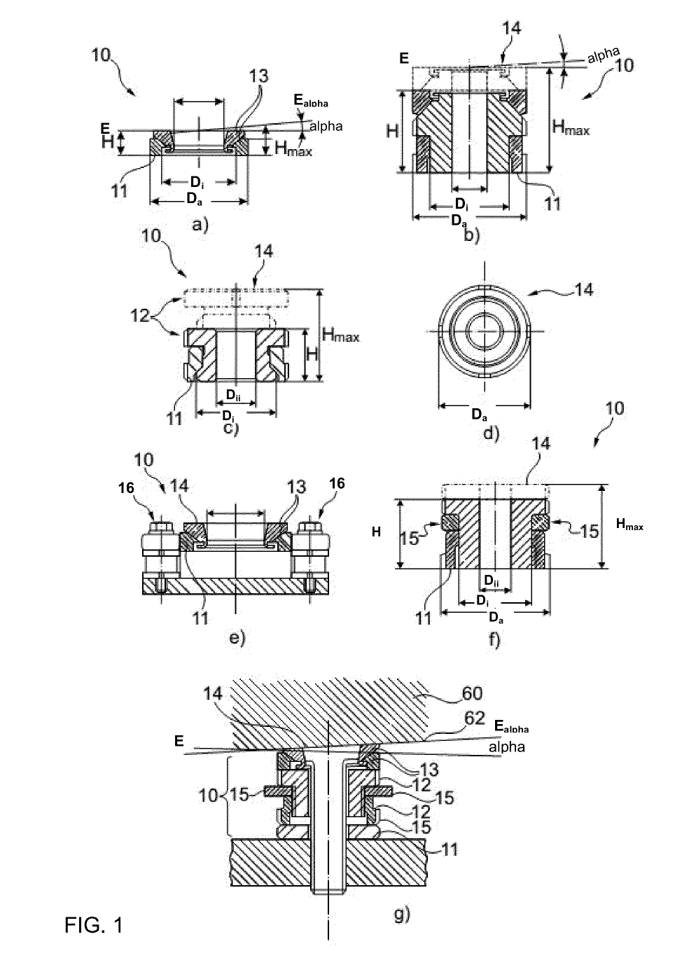

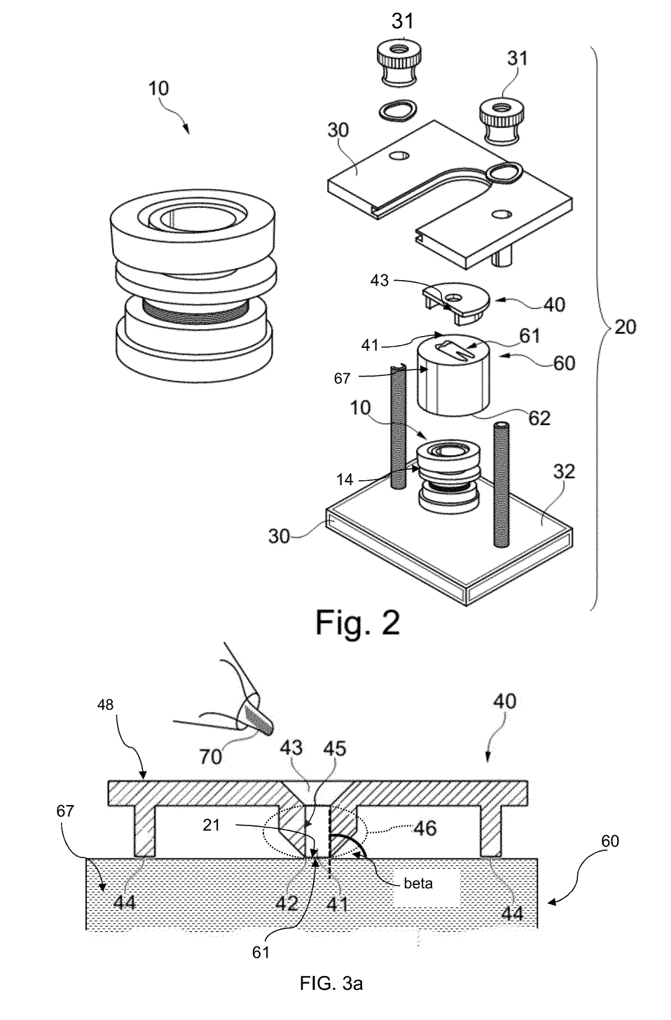

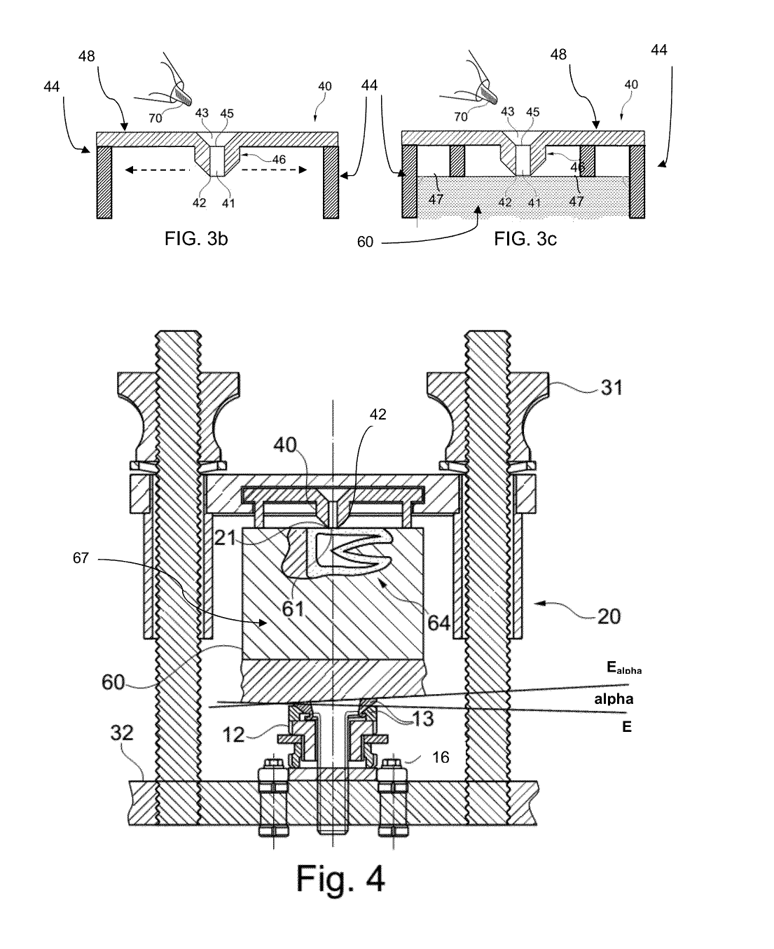

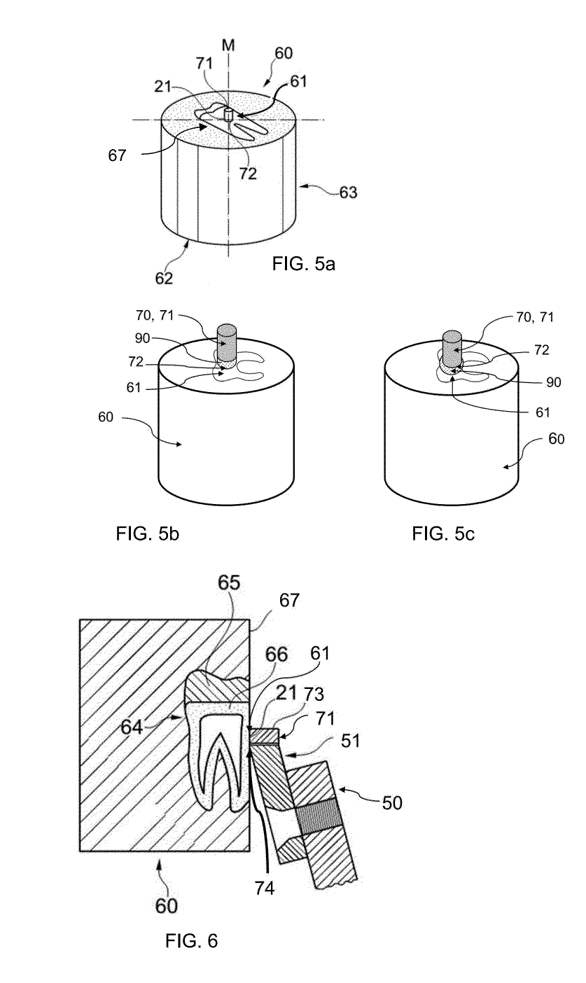

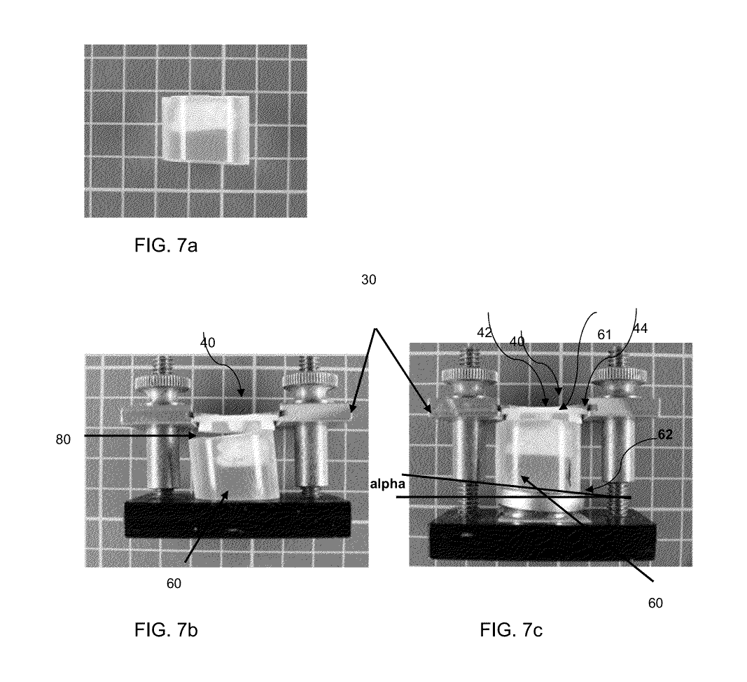

### REFERENCE NUMBERS

10 Adjusting element for alignment of the height and/or inclination of a surface
11 Base of the adjusting element 10
12 Height-adjustable component of the adjusting element 10
13 Angle-adjustable component, in particular ball-shaped element, of the adjusting element 10
14 Test body floor space of the adjusting element 10
15 Locking device for fixation of the adjusted height and/or inclination of the adjusting element 10
16 Fixation element for attachment of the adjusting element 10 in a device 20 and/or in a clamping facility 30
20 Device, in particular device for producing an adhesive bond
21 Contact surface, in particular contact surface of the three-dimensional mold 71 with the adhesive bond between a first surface 61 of the test body 60, for example a tooth, and a second surface 72
30 Clamping facility
31 Fixation element
32 Floor space in the clamping facility 30
40 Shaped part, in particular Ultradent shaped part
41 Lower sample opening of the sample well 46
42 Lower edge of the sample well 46
43 Upper sample opening of the sample well 46
44 Outer edge of the shaped part 40
45 Inner wall of the sample well 46
46 Sample well in the shaped part 40
47 Supports
48 Upper side of the shaped part 40
50 Device for exertion of a force, in particular a shearing force, thrust force and/or traction force
51 Shaped part for exertion of a force
60 Test body
61 First surface, in particular tooth surface, preferably enamel and/or dentine
62 Underside of the test body
63 Outer wall of the test body 60
64 Tooth
65 Enamel
66 Dentine
67 Embedding material, e.g. acrylic resin
70 Dental material, in particular adhering, self-adhesive or non-adhesive dental material
71 Three-dimensional mold comprising at least one dental material
72 Second surface, in particular of a mold 71
73 Outer surface of the mold 71
74 Force surface and/or contact surface between the mold 71 and the shaped part 51
80 Gap
90 Intermediate layer comprising at least one adhering dental material, such as adhesive and/or primer, self-etching primers, ceramic primers, metal primers

1. A method for aligning a first surface of a test body in a device, the method comprising:
providing at least one adjusting element;
aligning, with the at least one adjusting element, at least one of
a height and an inclination of the first surface of the test body into a plane-parallel position with respect to at least one of
at least one contact surface and at least one second surface in the device.

2. The method according to claim 1, further comprising:
positioning the at least one adjusting element on an underside of the test body.

3. The method according to claim 1, wherein at least one of
a) a height of the at least one adjusting element is adjustable either continuously or in steps in a range of more than or equal to 0 mm, and
b) an inclination of the at least one adjusting element is adjustable continuously or in steps up to an angle alpha of more than or equal to 0′ angular minutes between a plane E of the adjusting element and an underside of the test body.

4. The method according to claim 1, wherein the device is adapted for producing at least one adhesive bond on at least one contact surface and the at least one contact surface is bounded by an inner wall of a lower edge of a lower sample opening of a shaped part and by the first surface arranged below the lower edge of the shaped part.

5. The method according to claim 1, further comprising:
forming at least one adhesive bond on the at least one contact surface between
a) the first surface, which is selected from at least one of
natural dental surfaces and synthetic dental surfaces, comprising
(1) natural surfaces of the oral cavity of humans or animals, such as teeth, enamel, dentine, root cement, and periodontal membrane as well as lower jaw and upper jaw bones from humans and animals, or
(2) synthetic surfaces comprising prostheses, bridges, crowns, implants, bone replacement materials, filling materials, root filling materials, and veneering materials each comprising materials selected from metal, heavy metal, titanium, alloys, cements, ceramic materials, glass, plastic materials, and combinations of at least two of the afore-mentioned materials,
and
b) at least one second surface, selected from at least one of
(1) self-adhesive dental materials comprising one- and two-component dental materials comprising self-adhesive dental polymers, self-adhesive composite materials, self-adhesive filling materials/filling plastics, self-adhesive veneering materials/veneering plastics, self-adhesive prosthesis plastic materials, self-adhesive stump build-ups, self-adhesive cements, and self-adhesive fissure sealants, and
(2) adhering dental materials comprising adhesives, adhesives for tooth-plastic bonding, adhesives for tooth-ceramic bonding, adhesives for tooth-metal bonding, adhesives for metal-plastic bonding, adhesives for metal-ceramic bonding, adhesives for ceramic-plastic bonding, adhesives for plastic-plastic bonding, adhesives for ceramic-ceramic bonding.

6. The method according to claim 5, wherein the at least one adhesive bond is formed,
according to an alternative (a), between the first surface and the second surface of the self-adhesive dental material in the form of a three-dimensional mold, or
according to an alternative (b), between the first surface and the second surface of the adhering dental material in the form of at least one intermediate layer.

7. The method according to claim 6, wherein, according to alternative (b), the at least one intermediate layer forms a second adhesive bond with a non-adhesive dental material in the form of a three-dimensional mold, comprising one- and two-component dental materials comprising dental polymers, composite materials, filling materials/filling plastics, veneering materials/veneering plastics, cements, composite cements, stump build-ups, and fissure sealants.

8. A device for producing at least one adhesive bond on at least one contact surface between a first surface of a test body and at least one second surface, the device comprising
a clamping device for fixation of the first surface and
at least one adjusting element for alignment at least one of a height and an inclination of the first surface into a plane-parallel position with respect to the at least one contact surface.

9. The device according to claim 8, wherein at least one of
a) a height of the at least one adjusting element is adjustable either continuously or in steps in a range of more than or equal to 0 mm, and
b) an inclination of the at least one adjusting element is adjustable continuously or in steps up to an angle alpha of more than or equal to 0′ angular minutes between a plane E of the adjusting element and an underside of the test body.

10. The device according to claim 8, further comprising
a shaped part comprising an upper sample opening for introducing and positioning of a dental material in a sample well on the first surface and an inner wall of a lower edge of a lower sample opening and the first surface arranged below the lower edge of the shaped part forms the boundaries of the at least one contact surface,
wherein the at least one adjusting element is adapted for aligning at least one of the height and inclination of the first surface into the plane-parallel position with respect to at least one of the at least one contact surface and the lower edge of the shaped part.

11. The device according to claim 8, wherein the at least adjusting element comprises at least one of the following components: i) a lower base, ii) a height-adjustable component arranged above the base, iii) an angle-adjustable component arranged on said component, iv) an upper test body floor space, v) optionally, at least one locking device for fixing the position of the adjusted height and/or inclination, and vi) optionally, at least one fixation element that is connected to the base, for attachment of the adjusting element in a device.

12. The device according to claim 8, wherein the adjusting element is being positioned, by its base surface, on a standing surface of a clamping device in non-detachable or detachable manner.

13. The device according to claim 12, wherein the adjusting element, which is situated on a floor space of the clamping device in non-detachable manner or is positioned on its base in detachable manner, and the test body, which contacts the test body floor space of the adjusting element through its underside, is clamped in a force-locked manner and is not detachable for a duration of a method for producing one adhesive bond or a measuring process.

14. A method for producing an adhesive bond on at least one contact surface between a first surface of a test body and at least one second surface, wherein the contact surface is bounded by an inner wall of a lower edge of a lower sample opening of a shaped part and by the first surface arranged below the lower edge of the shaped part,
the method comprising the steps of:
a) positioning the test body by its underside on a test body floor space of an adjusting element, wherein at least one of
a height of the at least one adjusting element is adjustable either continuously or in steps in a range of more than or equal to 0 mm, and
an inclination of the at least one adjusting element is adjustable continuously or in steps up to an angle alpha of more than or equal to 0′ angular minutes between a plane E of the adjusting element and an underside of the test body;
b) aligning the first surface into a plane-parallel position with respect to the contact surface and at an angle beta of 90° with respect to the inner wall of a sample well of the shaped part;
c) contacting the first surface to the lower edge of the lower sample opening of the shaped part, whereby the lower edge is flush with the first surface;
d) introducing at least one dental material through the upper sample opening into the sample well;
e) forming at least one adhesive bond at the contact surface between the first surface and at least one second surface; and
f) obtaining an adhesive bond in the form of a three-dimensional mold according to an alternative (a), between the first surface and the second surface of a self-adhesive dental material in the form of a three-dimensional mold, or
according to an alternative (b), between the first surface and the second surface of a adhering dental material in the form of at least one intermediate layer.

15. A method according to claim 14, wherein, for step (b), the alignment of the first surface of the test body is done through the at least one adjusting element by adjusting at least one of the height and inclination of the adjusting element
with respect to the contact surface and the lower edge of the shaped part into a plane-parallel arrangement of the surfaces with respect to each other and the surfaces are at an angle beta of 90° with respect to the inner wall of the sample well, whereby at least one of
i) the angle alpha between a plane E of the adjusting element and the underside of the test body is adjustable in a range from more than or equal to 0′ angular minutes, and
ii) the height can be adjusted in a range from more than or equal to 0 mm, and optionally, set-up is fixed in place by means of at least one fixation element.

16. The method according to claim 14, wherein a defined contact surface is obtained in step c), whereby the inner wall of a sample well and the lower edge of the lower sample opening of a sample well are flush and free of gaps with respect to a first surface.

17. The method according to claim 14, wherein,
in step d), at least one self-adhesive dental material is introduced into the sample well onto a first surface and,
in step f), an adhesive bond according to alternative (a) is obtained or,
in step d), at least one non-adhesive dental material is applied into the sample well onto at least one intermediate layer containing at least one adhering dental material, whereby the at least one intermediate layer adheres to the first surface and to a second surface of a non-adhering dental material, and,
in step f), an adhesive bond according to an alternative (b) is obtained.

18. A method for determining the adhesive strength of at least one adhesive bond formed on at least one contact surface between a first surface of a test body and one dental material,
wherein the contact surface is defined by the boundaries formed by an inner wall of a lower edge of a lower sample opening of a shaped part and by the first surface arranged below the lower edge of the shaped part,
wherein the at least one adhesive bond is a three-dimensional mold comprising,
according to an alternative (a) at least one adhesive bond between a first surface and a second surface of a self-adhesive dental material in the form of a three-dimensional mold, or
according to an alternative (b) at least one adhesive bond between a first surface and a second surface of an adhering dental material in the form of at least one intermediate layer;
the method comprising the steps of
a) clamping the three-dimensional mold into a device comprising a shaped part for exertion of a force;
b) exerting at least one of a shearing force, a thrust force, and a traction force onto the at least one adhesive bond at the contact surface; and
c) measuring at least one of the shearing force, the thrust force, and the traction force applied at the time the at least one adhesive bond breaks.

19. The method according to claim 18, wherein,
for step a), the shaped part surrounds the three-dimensional mold along its longitudinal axis at least partially in shape-matching manner,
for step b), the force is exerted through the shaped part at a minimal force surface or contact surface at the outer surface of the mold, and,
for step c), the bond strength of the at least one adhesive bond is measured in units of force per contact surface area.

20. The method according to claim 19, wherein the method is in accordance with DIN EN ISO 29022.
